(19) United States
(12) Patent Application Publication
(10) Pub. No.: US 2026/0051537 A1
(43) Pub. Date: Feb. 19, 2026

(54) POSITIVE ELECTRODE MATERIAL, POSITIVE ELECTRODE, AND BATTERY

(71) Applicants: Panasonic Holdings Corporation, Osaka (JP); TOYOTA JIDOSHA KABUSHIKI KAISHA, Aichi (JP)

(72) Inventors: Masaki HIRASE, Hyogo (JP); Hiroki YABE, Osaka (JP); Takaaki TAMURA, Osaka (JP); Yusuke ITO, Nara (JP)

(21) Appl. No.: 19/368,422

(22) Filed: Oct. 24, 2025

Related U.S. Application Data
(63) Continuation of application No. PCT/JP2024/015945, filed on Apr. 23, 2024.

(30) Foreign Application Priority Data
May 16, 2023 (JP) 2023-081098

(51) Int. Cl. H01M 10/0562; H01M 4/02; H01M 4/62; H01M 10/0525

(52) U.S. Cl. CPC H01M 10/0562; H01M 4/625; H01M 2004/021; H01M 2004/028; H01M 10/0525; H01M 2300/008

(57) ABSTRACT

A positive electrode material according to the present disclosure includes: a positive electrode active material; a coating material including a first conductive material and a first solid electrolyte, the coating material coating at least a portion of a surface of the positive electrode active material; a second conductive material that is a fibrous carbon material; and a second solid electrolyte. The first solid electrolyte includes Li, Ti, M, and F, and the M is at least one selected from the group consisting of Ca, Mg, Al, Y, and Zr. The second conductive material has an average fiber diameter of 0.4 nm or more and 50 nm or less.

This application is a continuation of PCT/JP2024/015945 filed on Apr. 23, 2024, which claims foreign priority of Japanese Patent Application No. 2023-081098 filed on May 16, 2023, the entire contents of both of which are incorporated herein by reference.

### BACKGROUND OF THE INVENTION

### 1. Field of the Invention

The present disclosure relates to a positive electrode material, a positive electrode, and a battery.

### 2. Description of Related Art

WO 2021/187391 discloses a positive electrode material that includes a positive electrode active material and a first solid electrolyte material coating at least a portion of the surface of the positive electrode active material. The first solid electrolyte material includes Li, Ti, M1, and F, where M1 is at least one element selected from the group consisting of Ca, Mg, Al, Y, and Zr. WO 2021/187391 discloses that the positive electrode material further includes a second electrolyte material that is a material different from the first solid electrolyte material.

### SUMMARY OF THE INVENTION

The present disclosure aims to provide a positive electrode material that can reduce the initial resistance of the battery and can also suppress an increase in the resistance of the battery upon repeated charging and discharging.

A positive electrode material according to the present disclosure includes:
a positive electrode active material;
a coating material including a first conductive material and a first solid electrolyte, the coating material coating at least a portion of a surface of the positive electrode active material;
a second conductive material that is a fibrous carbon material; and
a second solid electrolyte, wherein
the first solid electrolyte includes Li, Ti, M, and F,
the M is at least one selected from the group consisting of Ca, Mg, Al, Y, and Zr, and
the second conductive material has an average fiber diameter of 0.4 nm or more and 50 nm or less.

The present disclosure provides a positive electrode material that can reduce the initial resistance of the battery and can also suppress an increase in the resistance of the battery upon repeated charging and discharging.

### BRIEF DESCRIPTION OF THE DRAWINGS

FIG. 1 is a cross-sectional view schematically showing the configuration of a positive electrode material according to Embodiment 1.

FIG. 2 is a cross-sectional view schematically showing the configuration of a positive electrode according to Embodiment 2.

FIG. 3 is a cross-sectional view schematically showing the configuration of a battery according to Embodiment 3.

FIG. 4 is a cross-sectional view schematically showing the configuration of a battery according to a modification.

FIG. 5 is a secondary electron image of a particle of a base active material of Example 1 captured with a scanning electron microscope (SEM).

FIG. 6 is a backscattered electron image of the particle of the base active material of Example 1, captured with an SEM, in the same observation region as in FIG. 5.

FIG. 7 is a cross-sectional secondary electron image of a positive electrode active material layer of Example 3 captured with an SEM.

FIG. 8 is an elemental mapping image showing the distribution of Ni obtained with an SEM-energy dispersive X-ray spectrometer (EDS) in the same observation region as in FIG. 7.

FIG. 9 is an elemental mapping image showing the distribution of Nb obtained with an SEM-EDS in the same observation region as in FIG. 7.

FIG. 10 is an elemental mapping image showing the distribution of C obtained with an SEM-EDS in the same observation region as in FIG. 7.

FIG. 11 shows an elemental mapping image of the distribution of F obtained with an SEM-EDS in the same observation region as in FIG. 7.

FIG. 12 is an elemental mapping image showing the distribution of S obtained with an SEM-EDS in the same observation region as in FIG. 7.

FIG. 13 is a cross-sectional backscattered electron image of the positive electrode active material layer of Example 3 captured with an SEM.

FIG. 14 is an enlarged view of a region A in FIG. 13.

### DETAILED DESCRIPTION

### Findings Underlying the Present Disclosure

A battery using a positive electrode material that includes a positive electrode active material and a solid electrolyte coating at least a portion of the surface of the positive electrode active material tends to have relatively high initial resistance. In WO 2021/187391, a second electrolyte material is added as a material for enhancing the mobility of Li ions, so that the ionic conductivity in the positive electrode is enhanced. This is intended to reduce the initial resistance of the battery and suppress an increase in the internal resistance of the battery upon charging. However, a battery using the positive electrode material disclosed in WO 2021/187391 may exhibit an increase in the resistance upon repeated charging and discharging.

The present inventors have conducted intensive studies in order to achieve a positive electrode material that can reduce the initial resistance of the battery and can also suppress an increase in the resistance of the battery upon repeated charging and discharging. As a result, the present inventors have come to conceive of the positive electrode material of the present disclosure.

Embodiments of the present disclosure are described below with reference to the drawings. The present disclosure is not limited to the embodiments described below.

### Embodiment 1

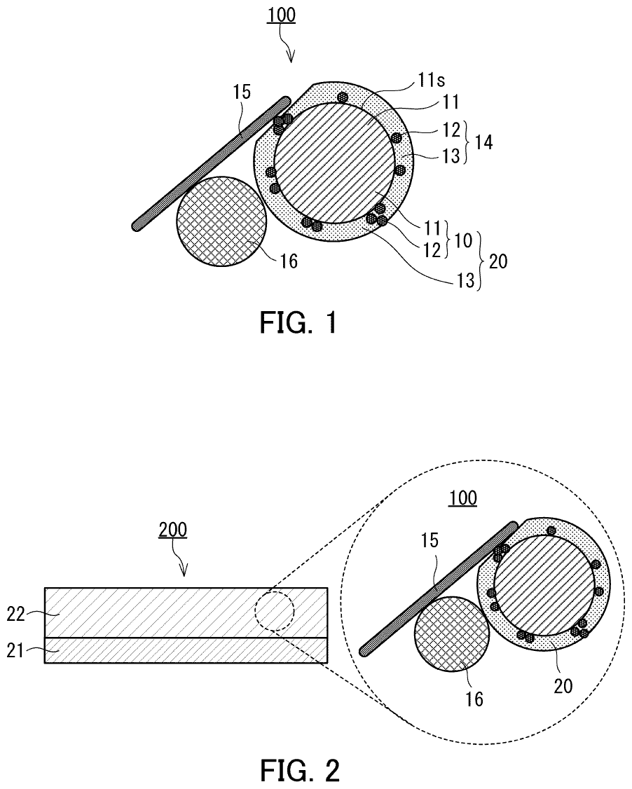

FIG. 1 is a cross-sectional view schematically showing the configuration of a positive electrode material 100 according to Embodiment 1.

The positive electrode material 100 includes a positive electrode active material 11, a coating material 14, a second conductive material 15, and a second solid electrolyte 16. The coating material 14 includes a first conductive material 12 and a first solid electrolyte 13. The coating material 14 coats at least a portion of a surface 11s of the positive electrode active material 11. The first solid electrolyte 13 includes Li, Ti, M, and F, and M is at least one selected from the group consisting of Ca, Mg, Al, Y, and Zr. The second conductive material 15 is a fibrous carbon material and has an average fiber diameter of 0.4 nm or more and 50 nm or less. The positive electrode material 100 according to Embodiment 1 can reduce the initial resistance of the battery and can also suppress an increase in the resistance of the battery upon repeated charging and discharging.

In a battery using a positive electrode material as disclosed in WO 2021/187391, a conductive material functions to ensure electronic conductivity and uniformity of the electrochemical reactions, both throughout the positive electrode active material layer. On the other hand, when the content of the conductive material in the positive electrode material is excessively high, the conductive material narrows the ionic conduction paths within the positive electrode active material layer, and consequently, uniformity of the electrochemical reactions may not be ensured.

The present inventors have found that, by using a fibrous carbon material having an average fiber diameter of 0.4 nm or more and 50 nm or less as a conductive material, the electronic conductivity of the positive electrode active material layer can be ensured even with a low content of the conductive material. However, when a positive electrode material that includes a positive electrode active material having a surface coated with the first solid electrolyte, the fibrous carbon material, and the second solid electrolyte is used to form a positive electrode active material layer, the fibrous carbon material is less likely to be embedded in the first solid electrolyte. Accordingly, contact between the positive electrode active material and the fibrous carbon material may be insufficient. When contact between the positive electrode active material and the fibrous carbon material is insufficient, uniformity of the electrochemical reactions in the positive electrode active material layer may not be ensured.

The present inventors have further conducted intensive studies in order to ensure uniformity of the electrochemical reactions in the positive electrode active material layer, and as a result, have conceived of including a conductive material also in the coating material that coats the positive electrode active material. In a positive electrode active material layer using the positive electrode material 100 according to Embodiment 1, an electronic conduction path can be formed between the positive electrode active material 11 and the second conductive material 15 via the first conductive material 12, and between the positive electrode active material 11 and the positive electrode active material 11 via the first conductive material 12. Accordingly, uniformity of the electrochemical reactions throughout the positive electrode active material layer is likely to be ensured. Consequently, the initial resistance of the battery can be reduced.

Furthermore, in the positive electrode material 100 according to Embodiment 1, the electronic conductivity of the positive electrode active material layer is ensured even with a low content of the second conductive material 15. Accordingly, the contact area between the second conductive material 15 and the second solid electrolyte 16 can be reduced. Consequently, the resistance of the battery is less likely to increase even after repeated charging and discharging.

Moreover, in a battery using a positive electrode material that includes the positive electrode active material 11 having a surface coated with the first solid electrolyte 13, the second conductive material 15, and the second solid electrolyte 16, the potential of the positive electrode active material 11 and the potential of the second conductive material 15 are likely to increase during charging of the battery. When the positive electrode active material 11 at high potential or the second conductive material 15 at high potential comes into contact with the first solid electrolyte 13 that has a narrow potential window on the high-potential side, i.e., low oxidation resistance, the first solid electrolyte 13 decomposes. Consequently, an oxidative decomposition layer is formed within the positive electrode active material layer. The oxidative decomposition layer functions as a resistance layer and thus can increase the internal resistance of the battery during charging. In the positive electrode material 100 according to Embodiment 1, the first solid electrolyte 13 includes Li, Ti, M, and F, and M is at least one selected from the group consisting of Ca, Mg, Al, Y, and Zr. Accordingly, the first solid electrolyte 13 is less likely to decompose even at high potential and has high oxidation resistance. Consequently, the resistance of the battery is less likely to increase even after repeated charging and discharging.

The average fiber diameter of the second conductive material 15 can be determined, for example, by SEM observation of a cross section of a positive electrode active material layer formed using the positive electrode material 100.

As shown in FIG. 1, the first conductive material 12 may be in direct contact with the surface 11s of the positive electrode active material 11. The first solid electrolyte 13 may be in direct contact with the first conductive material 12, and may be in direct contact with the surface 11s of the positive electrode active material 11. That is, the uncoated portion of the surface 11s of the positive electrode active material 11 that is not coated with the first conductive material 12 and a portion of the first conductive material 12 may be coated with the first solid electrolyte 13. A portion of the first conductive material 12 may not be coated with the first solid electrolyte 13 due to, for example, the flow of the first solid electrolyte 13, which has coated the first conductive material 12, during pressing of the positive electrode active material layer.

The first conductive material 12 coats at least a portion of the surface 11s of the positive electrode active material 11. Here, the positive electrode active material 11 in which at least a portion of the surface 11s is coated with the first conductive material 12 is defined as a base active material 10. The first solid electrolyte 13 coats at least a portion of the surface of the base active material 10, which includes the first conductive material 12 and the positive electrode active material 11. According to the above configuration, at least a portion of the first conductive material 12 is coated with the first solid electrolyte 13. Accordingly, due to the small contact area between the positive electrode active material 11 and the second solid electrolyte 16 and the small contact area between the first conductive material 12 and the second solid electrolyte 16, even when the potential of the positive electrode active material 11 and the potential of the first conductive material 12 increase during charging of the battery, the second solid electrolyte 16 is less likely to decompose. Consequently, an increase in the resistance of the battery upon repeated charging and discharging is further suppressed.

Here, the positive electrode active material 11 in which at least a portion of the surface 11s is coated with the coating material 14 is defined as a composite active material 20. The positive electrode material 100 includes the composite active material 20, the second conductive material 15, and the second solid electrolyte 16. The second conductive material 15 and the second solid electrolyte 16 are positioned between particles of the composite active material 20, which includes the positive electrode active material 11 and the coating material 14. According to the above configuration, the lithium-ion conductivity of the positive electrode active material layer is enhanced, and accordingly, the initial resistance of the battery can be reduced.

### (Positive Electrode Active Material)

Examples of the positive electrode active material 11 include a lithium-containing transition metal oxide, a lithium-containing transition metal phosphate, a transition metal fluoride, a polyanion material, a fluorinated polyanion material, a transition metal sulfide, a transition metal oxysulfide, and a transition metal oxynitride. In particular, when a lithium-containing transition metal oxide or a lithium-containing transition metal phosphate is used as the positive electrode active material, the battery can be manufactured at a reduced cost and can exhibit an increased average discharge voltage. Examples of lithium-containing transition metal oxides include lithium cobalt oxides, lithium nickel cobalt aluminum oxides, lithium nickel cobalt manganese oxides, and lithium nickel manganese oxides. Examples of lithium-containing transition metal phosphates include lithium iron phosphates, lithium vanadium phosphates, lithium cobalt phosphates, and lithium nickel phosphates. At least one selected from these positive electrode active materials can be used.

The particle of the positive electrode active material 11 may be a primary particle or a secondary particle. The positive electrode active material 11 has a median diameter of, for example, 0.1 μm or more and 100 μm or less. In the present disclosure, the term “median diameter” means the particle diameter at a cumulative volume equal to 50% (d50) in the volumetric particle size distribution. The volumetric particle size distribution is measured, for example, using a laser diffractometer or an image analyzer.

The positive electrode active material 11 may be in the form of a particle having a plurality of recesses on the surface 11s. In this case, the first conductive material 12 may be disposed in the plurality of recesses of the positive electrode active material 11. According to the above configuration, the initial resistance of the battery is further reduced and also an increase in the resistance of the battery upon repeated charging and discharging is further suppressed. The fact that the first conductive material 12 is disposed in the plurality of recesses of the positive electrode active material 11 can be confirmed, for example, from a secondary electron image or backscattered electron image of the particles of the base active material 10 captured with a scanning electron microscope (SEM).

The plurality of recesses may have an average spacing of 500 nm or less and an average height of 500 nm or less. According to the above configuration, a state is likely to be formed in which the first conductive material 12 is disposed in the recesses of the positive electrode active material 11 and the first conductive material 12 is not disposed on a portion of the positive electrode active material 11 other than the recesses. Accordingly, an increase in the contact area between the positive electrode active material 11 and the second solid electrolyte 16 and an increase in the contact area between the first conductive material 12 and the second solid electrolyte 16 can be suppressed. Consequently, the initial resistance of the battery is further reduced and also an increase in the resistance of the battery upon repeated charging and discharging is further suppressed.

### (First Conductive Material)

In the present embodiment, the first conductive material 12 is a particulate material. According to the above configuration, the first conductive material 12 is likely to adhere to the surface 11s of the positive electrode active material 11. Consequently, the initial resistance of the battery is further reduced and also an increase in the resistance of the battery upon repeated charging and discharging is further suppressed.

The shape of the first conductive material 12 may be, for example, spherical or ellipsoidal. The shape of the first conductive material 12 may be spherical.

The first conductive material 12 can be, for example, graphite, such as natural graphite or artificial graphite, carbon black, such as acetylene black or ketjen black, or a conductive polymer compound, such as a polyaniline compound, a polypyrrole compound, or a polythiophene compound.

The first conductive material 12 may include carbon black. According to the above configuration, the electronic conductivity of the positive electrode active material layer can be enhanced. The first conductive material 12 may be carbon black.

The carbon black can be, for example, acetylene black. When the first conductive material 12 includes acetylene black, the electronic conductivity of the positive electrode active material layer can be enhanced.

The first conductive material 12 may have a median diameter of 100 nm or less. According to the above configuration, the first conductive material 12 is more likely to adhere to the surface 11s of the positive electrode active material 11. Accordingly, an electronic conduction path resulting from connection of the first conductive material 12 and the second conductive material 15 is likely to be formed in the positive electrode active material layer. Consequently, the electronic conductivity of the positive electrode active material layer can be enhanced.

The lower limit of the median diameter of the first conductive material 12 is not particularly limited. The lower limit of the median diameter of the first conductive material 12 may be, for example, 10 nm.

### (Second Conductive Material)

In the present embodiment, the second conductive material 15 is a fibrous carbon material. According to the above configuration, the first conductive material 12, which is included in the coating material 14 coating at least a portion of the surface 11s of the positive electrode active material 11, and the second conductive material 15 are likely to be connected to each other. Consequently, the initial resistance of the battery is further reduced and also an increase in the resistance of the battery upon repeated charging and discharging is further suppressed.

Examples of the second conductive material 15 include a vapor-grown carbon fiber, a carbon nanotube, and a carbon nanofiber. The second conductive material 15 may include any one of these materials or any two or more of these materials. The second conductive material 15 may be formed of any one of these materials or any two or more of these materials.

The second conductive material 15 may include a carbon nanotube. For example, the second conductive material 15 that is a carbon nanotube and the second conductive material 15 other than carbon nanotubes may be present between a plurality of the composite active materials 20. The second conductive material 15 may be a carbon nanotube.

The second conductive material 15 has an average fiber diameter of 0.4 nm or more and 50 nm or less. According to the above configuration, the second conductive material 15 is likely to form an electronic conduction path in the positive electrode active material layer. Consequently, the electronic conductivity of the positive electrode active material layer can be enhanced.

The lower limit of the average fiber diameter of the second conductive material 15 may be 0.8 nm or 1.2 nm. The upper limit of the average fiber diameter of the second conductive material 15 may be 10 nm, 5 nm, or 2 nm.

The second conductive material 15 may have an average length of 5 μm or more. According to the above configuration, the second conductive material 15 is more likely to form an electronic conduction path in the positive electrode active material layer. Consequently, the electronic conductivity of the positive electrode active material layer can be further enhanced.

The upper limit of the average length of the second conductive material 15 is not particularly limited. The upper limit of the average length of the second conductive material 15 may be, for example, 20 μm.

The average length of the second conductive material 15 can be determined by the same method as the above-described method for determining the average fiber diameter of the second conductive material 15.

The ratio M₂/M₁ of the mass M₂ of the second conductive material 15 to the sum M₁ of the mass of the positive electrode active material 11 and the mass of the second conductive material 15 may be 0.005% or more and 0.02% or less. When the content of the second conductive material 15 in the positive electrode active material layer is excessively high, the contact area between the second conductive material 15 and the second solid electrolyte 16 increases, making the second solid electrolyte 16 likely to decompose during charging of the battery. When the ratio M₂/M₁ is 0.02% or less, decomposition of the second solid electrolyte 16 during charging of the battery is suppressed. Furthermore, when the content of the second conductive material 15 is excessively high, the second conductive material 15 narrows the ionic conduction paths in the positive electrode active material layer, and consequently, uniformity of the electrochemical reactions may not be ensured. When the ratio M₂/M₁ is 0.02% or less, uniformity of the electrochemical reactions is likely to be ensured.

The ratio M₂/M₁ can be determined, for example, from the mixing ratio.

### (First Solid Electrolyte)

The first solid electrolyte 13 includes Li, Ti, M, and F. M is at least one selected from the group consisting of Ca, Mg, Al, Y, and Zr. According to the above configuration, the first solid electrolyte 13 has high oxidation resistance that makes the first solid electrolyte 13 less likely to decompose at high potential.

The first solid electrolyte 13 may consist of Li, Ti, M, and F. The phrase “consist of Li, Ti, M, and F” means that no materials other than Li, Ti, M, and F are intentionally added, except for unavoidable impurities.

M may include Al. According to the above configuration, the lithium-ion conductivity of the first solid electrolyte 13 is enhanced. Consequently, the initial resistance of the battery can be reduced.

The first solid electrolyte 13 may include, for example, a solid electrolyte represented by the following composition formula (1). In the composition formula (1), α, β, γ, and δ are each independently a value greater than 0.

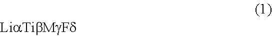

The solid electrolyte represented by the composition formula (1) exhibits higher ionic conductivity compared with solid electrolytes that consist of Li and a halogen element. Accordingly, when the solid electrolyte represented by the composition formula (1) is used in a battery, the charge and discharge efficiency of the battery can be enhanced.

In the composition formula (1), M may be Al to further enhance the ionic conductivity of the first solid electrolyte 13.

The first solid electrolyte 13 may include a solid electrolyte represented by the following composition formula (2). In the composition formula (2), M2 is at least one selected from the group consisting of Zr, Ni, Fe, and Cr, m is the valence of M2, and 0.1<x<0.9, 0≤y<0.1, 0≤z<0.1, and 0.8<b≤1.2 are satisfied.

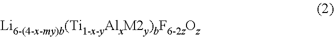

In the composition formula (2), when M2 includes a plurality of elements, m represents the sum of the products obtained by multiplying the composition ratio of each element by the valence of the element. For example, when M2 includes an element Me1 and an element Me2 where the composition ratio of the element Me1 is a1, the valence of the element Me1 is m1, the composition ratio of the element Me2 is a2, and the valence of the element Me2 is m2, then m is expressed as m1a1+m2a2.

The solid electrolyte 13 may consist substantially of Li, Ti, Al, and F. Here, the phrase “the halide solid electrolyte consists substantially of Li, Ti, Al, and F” means that the molar ratio (i.e., mole fraction) of the sum of the amounts of substance of Li, Ti, Al, and F to the total of the amounts of substance of all the elements constituting the halide solid electrolyte is 90% or more. In one example, the molar ratio (i.e., mole fraction) may be 95% or more. The solid electrolyte 13 may consist of Li, Ti, Al, and F.

In the above solid electrolyte, the ratio of the amount of substance of Li to the sum of the amounts of substance of Ti and Al may be 1.12 or more and 5.07 or less to further enhance the ionic conductivity of the first solid electrolyte 13.

The first solid electrolyte 13 may include a solid electrolyte represented by the following composition formula (3). In the composition formula (3), 0<x<1 and 0<b≤1.5 are satisfied.

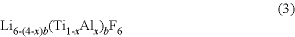

The solid electrolyte having this composition exhibits high ionic conductivity.

In the composition formula (3), 0.1≤x≤0.9 may be satisfied to enhance the ionic conductivity of the first solid electrolyte 13.

In the composition formula (3), 0.1≤x≤0.7 may be satisfied.

The upper and lower limits of the range of x in the composition formula (3) can be defined by any combination of numerical values selected from 0.1, 0.3, 0.4, 0.5, 0.6, 0.67, 0.7, 0.8, and 0.9.

In the composition formula (3), 0.8≤b≤1.2 may be satisfied to enhance the ionic conductivity of the first solid electrolyte 13.

The upper and lower limits of the range of b in the composition formula (3) can be defined by any combination of numerical values selected from 0.8, 0.9, 0.94, 1.0, 1.06, 1.1, and 1.2.

The above solid electrolyte may be crystalline or amorphous.

The shape of the first solid electrolyte 13 is not particularly limited and may be, for example, acicular, spherical, or ellipsoidal. For example, the first solid electrolyte 13 may be in particulate form.

When the first solid electrolyte 13 is in particulate form (e.g., spherical), the first solid electrolyte 13 has an average particle diameter of, for example, 10 nm or more and 100 nm or less. According to such a configuration, uniform coating with the coating material including the first solid electrolyte 13 is relatively easy.

The average particle diameter of the first solid electrolyte 13 can be measured, for example, using an SEM image. Specifically, in an SEM image, 20 particles of the first solid electrolyte 13 are randomly selected and the average value of their equivalent circle diameters is calculated to determine the average particle diameter. The average particle diameters of other materials such as the second solid electrolyte 16 described below can also be determined by the same method.

### (Second Solid Electrolyte)

The second solid electrolyte 16 includes a solid electrolyte having high ionic conductivity. The second solid electrolyte 16 may include a plurality of solid electrolytes having different chemical compositions. For example, the second solid electrolyte 16 present between the plurality of composite active materials 20 may include a solid electrolyte having a chemical composition different from that of the first solid electrolyte 13 and a solid electrolyte having the same chemical composition as that of the first solid electrolyte 13.

The second solid electrolyte 16 may include a halide solid electrolyte. Halide solid electrolytes have high ionic conductivity and excellent high-potential stability. Furthermore, halide solid electrolytes have low electronic conductivity and high oxidation resistance, and accordingly, are less likely to undergo oxidative decomposition caused by contact with the composite active material 20. Accordingly, including a halide solid electrolyte in the second solid electrolyte 16 can enhance the output characteristics of the battery.

The halide solid electrolyte can be, for example, Li₃(Ca,Y,Gd)X₆, Li₂MgX₄, Li₂FeX₄, Li(Al,Ga,In)X₄, Li₃(Al,Ga,In)X₆, or LiI. Here, in these halide solid electrolytes, the element X is at least one selected from the group consisting of Cl, Br, and I.

The halide solid electrolyte may be free of sulfur. In this case, generation of sulfur-containing gases, such as hydrogen sulfide gas, from the solid electrolyte can be avoided. A sulfur-free solid electrolyte means a solid electrolyte represented by a composition formula that is free of the element sulfur. Accordingly, a solid electrolyte containing a trace amount of sulfur, for example, a solid electrolyte having a sulfur content of 0.1 mass % or less, belongs to sulfur-free solid electrolytes. The halide solid electrolyte may further contain oxygen as an anion other than a halogen element.

The second solid electrolyte 16 may include a sulfide solid electrolyte. Sulfide solid electrolytes have narrower potential windows and accordingly are more likely to decompose at high potential, compared with solid electrolytes such as oxide solid electrolytes and halide solid electrolytes. However, according to the above configuration, since the contact area between the positive electrode active material 11 and the first conductive material 12, and the second solid electrolyte 16 is suppressed, an oxidative decomposition layer is less likely to be formed within the positive electrode active material layer. Consequently, the initial resistance of the battery can be reduced.

The sulfide solid electrolyte can be, for example, Li₂S—P₂S₅, Li₂S—SiS₂, Li₂S—B₂S₃, Li₂S—GeS₂, Li_{3.25}Ge_{0.25}P_{0.75}S₄, or Li₁₀GeP₂S₁₂. To these, LiX, Li₂O, MO_{q}, LiₚMO_{q}, or the like may be added. Here, the element X in “LiX” is at least one element selected from the group consisting of F, Cl, Br, and I. The element M in “MO_{q}” and “LiₚMO_{q}” is at least one element selected from the group consisting of P, Si, Ge, B, Al, Ga, In, Fe, and Zn. The symbols p and q in “MO_{q}” and “LiₚMO_{q}” are each independently a natural number.

The second solid electrolyte 16 may be a sulfide solid electrolyte. That is, the second solid electrolyte 16 may consist of a sulfide solid electrolyte. The phrase “consist of a sulfide solid electrolyte” means that no materials other than the sulfide solid electrolyte are intentionally added, except for unavoidable impurities. For example, the sulfide solid electrolyte may include lithium sulfide and phosphorus sulfide. For example, the sulfide solid electrolyte may be Li₂S—P₂S₅.

The shape of the second solid electrolyte 16 is not particularly limited and may be, for example, acicular, spherical, or ellipsoidal. For example, the second solid electrolyte 16 may be in particulate form.

When the second solid electrolyte 16 is in particulate form (e.g., spherical), the second solid electrolyte 16 may have an average particle diameter of, for example, 100 μm or less. When the average particle diameter is greater than 100 μm, the composite active material 20 and the second solid electrolyte 16 can fail to form a favorable dispersion state in the positive electrode material 100. Accordingly, the charge and discharge characteristics are reduced. The average particle diameter of the second solid electrolyte 16 may be 10 μm or less. When the average particle diameter of the second solid electrolyte 16 falls within the above range, the composite active material 20 and the second solid electrolyte 16 can form a favorable dispersion state in the positive electrode material 100.

The average particle diameter of the second solid electrolyte 16 may be smaller than the average particle diameter of the composite active material 20. According to such a configuration, the composite active material 20 and the second solid electrolyte 16 can form a more favorable dispersion state in the electrode.

The average particle diameter of the composite active material 20 may be 0.1 μm or more and 100 μm or less. When the average particle diameter of the composite active material 20 is 0.1 μm or more, the composite active material 20 and the second solid electrolyte 16 can form a favorable dispersion state in the positive electrode material 100. This enhances the charge and discharge characteristics of the battery. Furthermore, when the average particle diameter of the composite active material 20 is 100 μm or less, the lithium diffusion rate within the positive electrode active material 11 increases. This enables high-power operation of the battery.

The average particle diameter of the composite active material 20 may be larger than the average particle diameter of the second solid electrolyte 16. Even with such a configuration, the composite active material 20 and the second solid electrolyte 16 can form a favorable dispersion state in the electrode.

The coating material 14 may further include, as an underlayer material, a material such as an oxide material or an oxide solid electrolyte. The coating material 14 may form a first layer including the underlayer material and a second layer including the first conductive material 12 and the first solid electrolyte 13. The underlayer material may be a material including Nb. The underlayer material typically includes lithium niobate (LiNbO₃). According to such a configuration, the charge and discharge efficiency of the battery can be enhanced. An oxide solid electrolyte serving as the underlayer material can also be any of the oxide solid electrolytes described below.

In the positive electrode material 100, the second solid electrolyte 16 and the composite active material 20 may be in contact with each other, as shown in FIG. 1.

The positive electrode material 100 may include a plurality of the composite active materials 20, a plurality of the second conductive materials 15, and a plurality of the second solid electrolytes 16.

The form of the positive electrode material 100 is not particularly limited. The positive electrode material 100 may be in powder form or slurry form. Furthermore, the positive electrode material 100 may be in the form of a compact obtained by pressing the positive electrode material 100.

### <Method for Manufacturing Positive Electrode Material>

The positive electrode material 100 can be manufactured, for example, by the following method.

First, the surface of the particle of the positive electrode active material 11 is coated with the first conductive material 12 to prepare the base active material 10. Next, the surface of the particle of the base active material 10 is coated with the first solid electrolyte 13 to prepare the composite active material 20. The respective methods for coating with the first conductive material 12 and the first solid electrolyte 13 are not particularly limited. For example, by mixing the particle of the positive electrode active material 11 and the particle of the first conductive material 12, a particle of the base active material 10 is obtained in which the surface of the particle of the positive electrode active material 11 is coated with the first conductive material 12. By mixing the particle of the base active material 10 and the particle of the first solid electrolyte 13, a particle of the composite active material 20 is obtained in which the surface of the particle of the base active material 10 is coated with the first solid electrolyte 13.

By mixing the particles of the composite active material 20, the particles of the second conductive material 15, and the particles of the second solid electrolyte 16, the positive electrode material 100 is obtained.

### Embodiment 2

FIG. 2 is a cross-sectional view schematically showing the configuration of a positive electrode 200 according to Embodiment 2. The positive electrode 200 includes a positive electrode current collector 21 and a positive electrode active material layer 22 supported on the positive electrode current collector 21. The positive electrode active material layer 22 includes the positive electrode material 100 of Embodiment 1. That is, the positive electrode active material layer 22 includes the composite active material 20, the second conductive material 15, and the second solid electrolyte 16. The positive electrode 200 according to Embodiment 2 can reduce the initial resistance of the battery and can also suppress an increase in the resistance of the battery upon repeated charging and discharging.

The volume ratio “v1:100−v1” between the positive electrode active material 11 and the sum of the volumes of the first conductive material 12, the first solid electrolyte 13, the second conductive material 15, and the second solid electrolyte 16 may satisfy 30≤v1≤95. Here, v1 represents the volume fraction of the positive electrode active material 11 when the sum of the volumes of the positive electrode active material 11, the first conductive material 12, the first solid electrolyte 13, the second conductive material 15, and the second solid electrolyte 16 included in the positive electrode active material layer 22 is taken as 100. When 30≤v1 is satisfied, sufficient energy density of the battery is likely to be ensured. When v1≤95 is satisfied, high-power operation of the battery is further facilitated.

The material of the positive electrode current collector 21 is not limited to any particular material and can be any material commonly used in batteries. Examples of the material of the positive electrode current collector 21 include aluminum, an aluminum alloy, stainless steel, carbon, and a conductive resin. The form of the positive electrode current collector 21 is also not limited to any particular form. Examples of the form include foil, film, and sheet. The surface of the positive electrode current collector 21 may have unevenness imparted.

### Embodiment 3

A battery according to Embodiment 3 includes the positive electrode of Embodiment 2 and a negative electrode. The battery according to Embodiment 3 may be a solid-state battery or a flooded battery. In the present disclosure, the term “solid-state battery” means a battery that uses a solid electrolyte as the electrolyte. A solid-state battery is typically an all-solid-state battery that includes no electrolyte solution. In the present disclosure, the term “flooded battery” means a battery that uses an electrolyte solution. The battery according to Embodiment 3 can reduce the initial resistance and can also suppress an increase in the resistance upon repeated charging and discharging.

FIG. 3 is a cross-sectional view schematically showing the configuration of a battery 300 according to Embodiment 3. As shown in FIG. 3, the battery 300 may include the positive electrode 200 of Embodiment 2, an electrolyte layer 201, and a negative electrode 202. The electrolyte layer 201 is disposed between the positive electrode 200 and the negative electrode 202.

### (Electrolyte Layer)

The electrolyte layer 201 is a layer that includes an electrolyte. The electrolyte is, for example, a solid electrolyte. The solid electrolyte included in the electrolyte layer 201 is referred to as a third solid electrolyte. That is, the electrolyte layer 201 may include the third solid electrolyte.

The third solid electrolyte may be a halide solid electrolyte, a sulfide solid electrolyte, an oxide solid electrolyte, a polymer solid electrolyte, or a complex hydride solid electrolyte. As the third solid electrolyte, a material selected from the above materials that is less likely to undergo decomposition at the potential of the negative electrode active material used may be used.

The third solid electrolyte may include a solid electrolyte having the same composition as that of the solid electrolyte included in the first solid electrolyte 13.

The third solid electrolyte may include a solid electrolyte having the same composition as that of the solid electrolyte included in the second solid electrolyte 16.

The third solid electrolyte may include a solid electrolyte having a composition different from that of the solid electrolyte included in the first solid electrolyte 13.

When the third solid electrolyte includes a halide solid electrolyte, the third solid electrolyte may include a halide solid electrolyte having the same composition as that of the halide solid electrolyte included in the second solid electrolyte 16. That is, the electrolyte layer 201 may include a halide solid electrolyte having the same composition as that of the halide solid electrolyte included in the second solid electrolyte 16.

The third solid electrolyte may include a solid electrolyte having a composition different from that of the solid electrolyte included in the second solid electrolyte 16.

When the third solid electrolyte includes a halide solid electrolyte, the third solid electrolyte may include a halide solid electrolyte having a composition different from that of the halide solid electrolyte included in the second solid electrolyte 16. That is, the electrolyte layer 201 may include a halide solid electrolyte having a composition different from that of the halide solid electrolyte included in the second solid electrolyte 16.

The third solid electrolyte may include a sulfide solid electrolyte. The third solid electrolyte may include a sulfide solid electrolyte having the same composition as that of the sulfide solid electrolyte included in the second solid electrolyte 16. That is, the electrolyte layer 201 may include a sulfide solid electrolyte having the same composition as that of the sulfide solid electrolyte included in the second solid electrolyte 16.

According to the above configuration, the energy density of the battery 300 can be enhanced. Furthermore, when the electrolyte layer 201 includes a sulfide solid electrolyte having the same composition as that of the sulfide solid electrolyte included in the first solid electrolyte 13, the initial resistance of the battery 300 can be further reduced.

The third solid electrolyte may include an oxide solid electrolyte. The oxide solid electrolyte can be, for example, a NASICON-type solid electrolyte material typified by LiTi₂(PO₄)₃ and element-substituted substances thereof, a (LaLi)TiO₃-based perovskite-type solid electrolyte material, a LISICON-type solid electrolyte material typified by Li₁₄ZnGe₄O₁₆, Li₄SiO₄, and LiGeO₄ and element-substituted substances thereof, a garnet-type solid electrolyte material typified by Li₇La₃Zr₂O₁₂ and element-substituted substances thereof, Li₃PO₄ and N-substituted substances thereof, or a glass or glass-ceramic based on a Li—B—O compound, such as LiBO₂ or Li₃BO₃, to which Li₂SO₄ or Li₂CO₃, or the like is added.

The third solid electrolyte may include a polymer solid electrolyte. The polymer solid electrolyte can be, for example, a compound of a polymer compound and a lithium salt. The polymer compound may have an ethylene oxide structure. The polymer compound having an ethylene oxide structure can contain a large amount of a lithium salt. Accordingly, the ionic conductivity can be further enhanced. The lithium salt can be LiPF₆, LiBF₄, LiSbF₆, LiAsF₆, LiSO₃CF₃, LiN(SO₂F)₂, LiN(SO₂CF₃)₂, LiN(SO₂C₂F₅)₂, LiN(SO₂CF₃)(SO₂C₄F₉), LiC(SO₂CF₃)₃, or the like. One lithium salt may be used alone, or two or more lithium salts may be used in combination.

The third solid electrolyte may include a complex hydride solid electrolyte. The complex hydride solid electrolyte can be, for example, LiBH₄—LiI or LiBH₄—P₂S₅.

### (Negative Electrode)

The negative electrode 202 includes a negative electrode current collector 23 and a negative electrode active material layer 24 supported on the negative electrode current collector 23. The negative electrode active material layer 24 includes a material having properties of occluding and releasing metal ions (e.g., lithium ions). The negative electrode active material layer 24 includes, for example, a negative electrode active material (e.g., negative electrode active material particles).

The negative electrode active material can be a metal material, a carbon material, an oxide, a nitride, a tin compound, a silicon compound, or the like. The metal material may be a simple substance of metal. The metal material may be an alloy. Examples of the metal material include lithium metal and a lithium alloy. Examples of the carbon material include natural graphite, spherical carbon, artificial graphite, and amorphous carbon. From the viewpoint of capacity density, silicon, tin, a silicon compound, or a tin compound can be suitably used.

The negative electrode active material layer 24 may include a solid electrolyte. The solid electrolyte included in the negative electrode active material layer 24 is referred to as a fourth solid electrolyte. That is, the negative electrode active material layer 24 may include the fourth solid electrolyte. According to such a configuration, the lithium-ion conductivity within the negative electrode active material layer 24 is enhanced, enabling high-power operation of the battery 300. As the fourth solid electrolyte included in the negative electrode active material layer 24, a material that does not undergo decomposition at the potential of the negative electrode active material used, selected from the materials listed as examples of the third solid electrolyte in the electrolyte layer 201, can be used.

The average particle diameter of the negative electrode active material may be larger than the average particle diameter of the fourth solid electrolyte included in the negative electrode active material layer 24. This enables the formation of a favorable dispersion state between the negative electrode active material and the fourth solid electrolyte.

The volume ratio “v2:100−v2” between the negative electrode active material and the fourth solid electrolyte included in the negative electrode active material layer 24 may satisfy 30≤v2≤95. Here, v2 represents the volume ratio of the negative electrode active material when the sum of the volumes of the negative electrode active material and the fourth solid electrolyte included in the negative electrode active material layer 24 is taken as 100. When 30≤v2 is satisfied, sufficient energy density of the battery 300 is likely to be ensured. When v2≤95 is satisfied, high-power operation of the battery 300 is further facilitated.

The material of the negative electrode current collector 23 is not limited to any particular material and can be any material commonly used in batteries. Examples of the material of the negative electrode current collector 23 include copper, a copper alloy, aluminum, an aluminum alloy, stainless steel, nickel, and a conductive resin. The form of the negative electrode current collector 23 is also not limited to any particular form. Examples of the form include foil, film, and sheet. The surface of the negative electrode current collector 23 may have unevenness imparted.

At least one selected from the group consisting of the positive electrode active material layer 22, the electrolyte layer 201, and the negative electrode active material layer 24 may include a binder for the purpose of enhancing the adhesion between particles. The binder is used to enhance the binding properties of the materials constituting the electrodes. The binder can be a copolymer of two or more materials selected from the group consisting of polyvinylidene fluoride, polytetrafluoroethylene, polyethylene, polypropylene, an aramid resin, a polyamide, a polyimide, a polyamide-imide, polyacrylonitrile, a polyacrylic acid, polyacrylic acid methyl ester, polyacrylic acid ethyl ester, polyacrylic acid hexyl ester, a polymethacrylic acid, polymethacrylic acid methyl ester, polymethacrylic acid ethyl ester, polymethacrylic acid hexyl ester, polyvinyl acetate, polyvinylpyrrolidone, a polyether, a polyethersulfone, hexafluoropolypropylene, styrene-butadiene rubber, carboxymethyl cellulose, tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, an acrylic acid, and hexadiene. Furthermore, the binder may be a mixture of two or more selected from the above.

The negative electrode active material layer 24 may include a conductive material for the purpose of enhancing the electronic conductivity. The conductive material can be, for example, graphite, such as natural graphite or artificial graphite, carbon black, such as acetylene black or ketjen black, a carbon fiber, or a conductive polymer compound, such as a polyaniline compound, a polypyrrole compound, or a polythiophene compound. The use of a conductive carbon material can achieve cost reduction.

### (Modification)

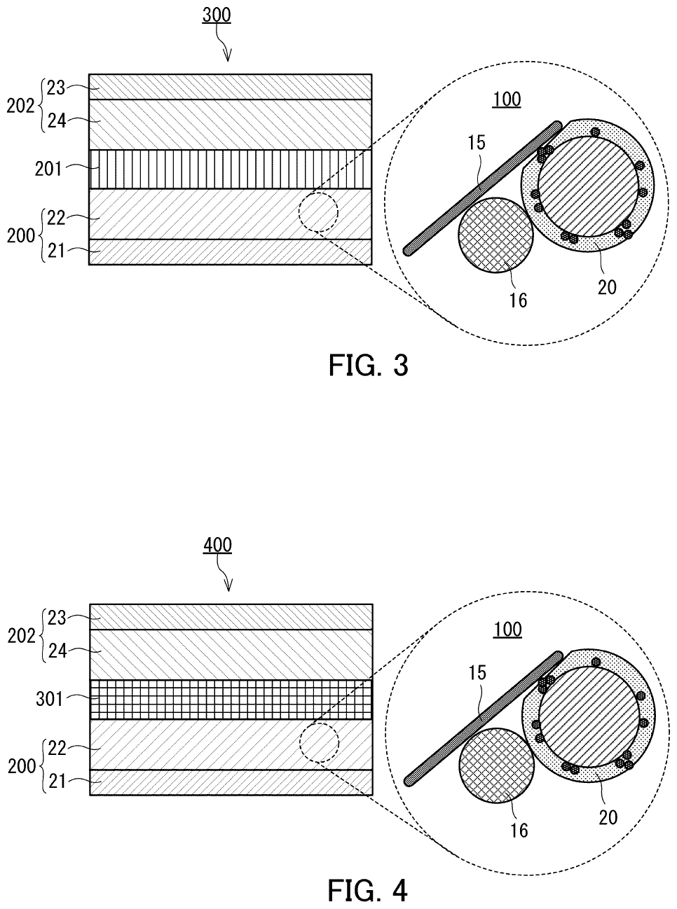

FIG. 4 is a cross-sectional view schematically showing the configuration of a battery 400 according to a modification. The battery 400 shown in FIG. 4 includes the positive electrode 200 of Embodiment 2, a separator 301, and the negative electrode 202. The battery 400 has the same configuration as the above-described battery 300, except that the separator 301 is included instead of the electrolyte layer 201.

The separator 301 is positioned between the positive electrode 200 and the negative electrode 202, preventing direct contact between the positive electrode 200 and the negative electrode 202. The separator 301 can sufficiently ensure the safety of the battery 400.

The separator 301 has lithium-ion conductivity. The material of the separator 301 may be any material through which lithium ions are allowed to pass.

Examples of the material of the separator 301 include a porous material. The separator 301 may be in a membrane form. When the separator 301 is a porous membrane, examples of porous membranes include woven fabrics, nonwoven fabrics, porous membranes made of a polyolefin resin, and porous membranes formed of glass paper obtained by weaving glass fibers into a nonwoven fabric.

The separator 301 may be impregnated with an electrolyte solution. According to the above configuration, both high charge and discharge efficiency and high discharge capacity of the battery 400 can be achieved.

The electrolyte solution may contain at least one selected from the group consisting of a cyclic ether, a glyme, and a sulfolane. The electrolyte solution may contain an ether. Examples of the ether include a cyclic ether and a glycol ether. The glycol ether may be a glyme represented by the composition formula CH₃(OCH₂CH₂)ₙOCH₃. In the above composition formula, n is an integer equal to or greater than 1. The electrolyte solution may contain, as a solvent, a mixture of a cyclic ether and a glyme, or a cyclic ether.

Examples of the cyclic ether include tetrahydrofuran (THF), 2-methyltetrahydrofuran (2MeTHF), 2,5-dimethyltetrahydrofuran, 1,3-dioxolane (1,3DO), and 4-methyl-1,3-dioxolane (4Me1,3DO). One, or a mixture of two or more, selected from the above can be used.

Examples of the glyme include monoglyme (1,2-dimethoxyethane), diglyme (diethylene glycol dimethyl ether), triglyme (triethylene glycol dimethyl ether), tetraglyme (tetraethylene glycol dimethyl ether), pentaethylene glycol dimethyl ether, and polyethylene glycol dimethyl ether. The glyme may be a mixture of tetraglyme and pentaethylene glycol dimethyl ether.

Examples of the sulfolane include 3-methylsulfolane.

The electrolyte solution may contain an electrolyte salt. Examples of the electrolyte salt include lithium salts such as LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, LiClO₄, and lithium bisoxalatoborate. The electrolyte solution may contain lithium dissolved therein.

The battery 300 and the battery 400 can each be configured as a battery in any of various forms such as a coin type, a cylindrical type, a prismatic type, a sheet type, a button type, a flat type, and a stacked type.

### Other Embodiments

### (Supplementary Description)

The above description of the embodiments discloses the following techniques.

### (Technique 1)

A positive electrode material including:
a positive electrode active material;
a coating material including a first conductive material and a first solid electrolyte, the coating material coating at least a portion of a surface of the positive electrode active material;
a second conductive material that is a fibrous carbon material; and
a second solid electrolyte, wherein
the first solid electrolyte includes Li, Ti, M, and F,
the M is at least one selected from the group consisting of Ca, Mg, Al, Y, and Zr, and
the second conductive material has an average fiber diameter of 0.4 nm or more and 50 nm or less.

The positive electrode material according to Technique 1 can reduce the initial resistance of the battery and can also suppress an increase in the resistance of the battery upon repeated charging and discharging.

### (Technique 2)

The positive electrode material according to Technique 1, wherein the first conductive material coats at least a portion of the surface of the positive electrode active material, and the first solid electrolyte coats at least a portion of a surface of a base active material, the base active material including the first conductive material and the positive electrode active material. According to this configuration, an increase in the resistance of the battery upon repeated charging and discharging is further suppressed.

### (Technique 3)

The positive electrode material according to Technique 1 or 2, wherein the second conductive material and the second solid electrolyte are positioned between particles of a composite active material, the composite active material including the positive electrode active material and the coating material. According to this configuration, the initial resistance of the battery is further reduced and also an increase in the resistance of the battery upon repeated charging and discharging is further suppressed.

### (Technique 4)

The positive electrode material according to any one of Techniques 1 to 3, wherein the M includes Al. According to this configuration, the lithium-ion conductivity of the first solid electrolyte is enhanced. Consequently, the initial resistance of the battery can be reduced.

### (Technique 5)

The positive electrode material according to any one of Techniques 1 to 4, wherein a ratio of a mass of the second conductive material to a sum of a mass of the positive electrode active material and the mass of the second conductive material is 0.005% or more and 0.02% or less. According to this configuration, uniformity of the electrochemical reactions is likely to be ensured.

### (Technique 6)

The positive electrode material according to any one of Techniques 1 to 5, wherein the second solid electrolyte includes a sulfide solid electrolyte. According to this configuration, the initial resistance of the battery can be reduced.

### (Technique 7)

The positive electrode material according to any one of Techniques 1 to 6, wherein the first conductive material is a particulate material. According to this configuration, the initial resistance of the battery is further reduced and also an increase in the resistance of the battery upon repeated charging and discharging is further suppressed.

### (Technique 8)

The positive electrode material according to any one of Techniques 1 to 7, wherein the first conductive material has a median diameter of 100 nm or less. According to this configuration, an electronic conduction path resulting from connection of the first conductive material and the second conductive material is likely to be formed in the positive electrode active material layer. Consequently, the electronic conductivity of the positive electrode active material layer can be enhanced.

### (Technique 9)

The positive electrode material according to any one of Techniques 1 to 8, wherein the positive electrode active material is in a form of a particle having a plurality of recesses on a surface thereof, and the first conductive material is disposed in the plurality of recesses. According to this configuration, the initial resistance of the battery is further reduced and also an increase in the resistance of the battery upon repeated charging and discharging is further suppressed.

### (Technique 10)

A positive electrode including:
a positive electrode current collector; and
a positive electrode active material layer supported on the positive electrode current collector, wherein
the positive electrode active material layer includes the positive electrode material according to any one of Techniques 1 to 9.

The positive electrode according to Technique 10 can reduce the initial resistance of the battery and can also suppress an increase in the resistance of the battery upon repeated charging and discharging.

### (Technique 11)

A battery including:
the positive electrode according to Technique 10; and
a negative electrode.

The battery according to Technique 11 can reduce the initial resistance and can also suppress an increase in the resistance upon repeated charging and discharging.

### (Technique 12)

The battery according to Technique 11, further including an electrolyte layer positioned between the positive electrode and the negative electrode.

The battery according to Technique 12 can reduce the initial resistance and can also suppress an increase in the resistance upon repeated charging and discharging.

### EXAMPLES

The present disclosure is described in detail below with reference to examples and comparative examples. The following examples are merely illustrative, and the present disclosure is not limited to the following examples.

### Examples 1 to 4

### [Positive Electrode Active Material]

As the positive electrode active material, core-shell composite particles (median diameter: 5 μm; density: 4.7 g/cm³) were used. The core-shell composite particle had a core formed of Li(Ni,Co,Al)O₂ and a shell formed of LiNbO₃. The median diameter of the positive electrode active material was measured using a laser diffractometer (SALD-2000, manufactured by Shimadzu Corporation).

### [First Conductive Material]

As the first conductive material, particles of acetylene black (Li-435, manufactured by Denka Company Limited; average particle diameter: 23 nm) were used. The median diameter of the particles of the acetylene black measured from an SEM image was 25 nm.

### [First Solid Electrolyte]

In a glove box in an argon atmosphere, LiF, TiF₄, and AlF₃ as the raw material powders were weighed so that the molar ratio of LiF:TiF₄:AlF₃ would be 2.7:0.3:0.7. These raw material powders were mixed in an agate mortar to obtain a mixture. Next, the mixture was milled in a planetary ball mill (Model P-7, manufactured by Fritsch GmbH) under the conditions of the rotational speed of 500 rpm and 12 hours or more. Thus, particles of a compound represented by the composition formula Li_{2.7}Ti_{0.3}Al_{0.7}F₆ (hereinafter referred to as LTAF) (average particle diameter: 10 nm to 100 nm; density: 2.7 g/cm³) were obtained. The particles obtained were used as the first solid electrolyte. The average particle diameter of the first solid electrolyte was determined by observing the particles of the LTAF with a scanning electron microscope (Regulus SU8230, manufactured by Hitachi High-Tech Corporation) at a magnification of 20,000, randomly selecting 20 particles therefrom, and calculating their equivalent circle diameters.

### [First Binder]

As a first binder, a styrene-ethylene-butylene-styrene block copolymer (N504, manufactured by Asahi Kasei Corporation) was dissolved in a dispersion medium to prepare a solution. The content of the styrene-ethylene-butylene-styrene block copolymer was 5 mass % relative to the total mass of the solution.

### [Second Binder]

As a second binder, a butadiene rubber-based binder was dissolved in a dispersion medium to prepare a solution. The content of the butadiene rubber-based binder was 5 mass % relative to the total mass of the solution.

### [Second Conductive Material]

As the second conductive material, a single-walled carbon nanotube (TUBALL SWCNT, manufactured by OCSiAl; fiber diameter: 1.6±0.4 nm; length: 5 μm or more) (hereinafter referred to as CNT) was used.

The second conductive material was mixed with the first binder solution and a solvent to prepare a dispersion of the second conductive material. The contents of the CNT and the styrene-ethylene-butylene-styrene block copolymer were 0.2 mass % and 0.6 mass %, respectively, relative to the total mass of the dispersion.

### [Second Solid Electrolyte]

As the second solid electrolyte, LiI—LiBr—Li₂S—P₂S₅-based glass-ceramic particles (average particle diameter: 1.0 μm; density: 2.2 g/cm³) were used. The average particle diameter of the second solid electrolyte was calculated by the same method as that for the first solid electrolyte.

### [First Coating Step]

The positive electrode active material and the first conductive material were placed in an agate mortar and mixed so that the mass ratio of the positive electrode active material: the first conductive material would be 99.5:0.5. Thus, particles of the positive electrode active material, at least a portion of the surface of each of which was coated with the first conductive material, that is, particles of the base active material, were obtained.

### [SEM Analysis]

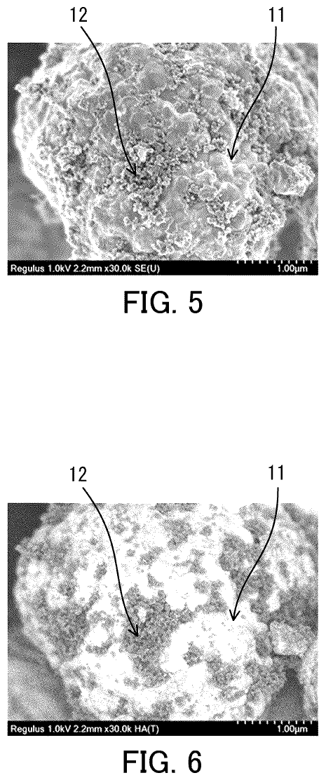

FIG. 5 shows an example of a secondary electron image of the particle of the base active material of Example 1 captured with a scanning electron microscope (Regulus SU8230, manufactured by Hitachi High-Tech Corporation). FIG. 6 shows an example of a backscattered electron image of the particle of the base active material of Example 1 captured with an SEM in the same observation region as that in the secondary electron image of FIG. 5. The accelerating voltage of the scanning electron microscope was 1 kV.

Secondary electron images have the characteristic that the surface morphology (e.g., unevenness) of a specimen is easily reflected in the image contrast. Backscattered electron images have the characteristic that the composition of a specimen is easily reflected in the image contrast. In backscattered electron images, a material having a higher atomic number and a higher density appears brighter. As shown in FIG. 5, particles having diameters of approximately 10 nm to approximately 50 nm were particles of the acetylene black as the first conductive material 12. As shown in FIG. 6, the region where the surface of the positive electrode active material 11 was coated with the first conductive material 12 appeared in a darker color tone compared with the region where the surface of the positive electrode active material 11 was not coated with the first conductive material 12.

As shown in FIGS. 5 and 6, the positive electrode active material 11 had a plurality of recesses on its surface, and the first conductive material 12 was disposed in the plurality of recesses.

### [Second Coating Step]

The particles of the base active material and the particles of the first solid electrolyte were mixed in a vessel together with a plurality of zirconia balls (diameter: 3 mm) so that the volume ratio of the positive electrode active material: the first solid electrolyte would be 90:10. Thus, a mixture was obtained. Next, the mixture was mixed in a planetary centrifugal mixer (ARE-310, manufactured by THINKY CORPORATION) under the conditions of the rotational speed of 1,200 rpm and 6 minutes. Thus, the particles of the base active material, at least a portion of the surface of each of which was coated with the first solid electrolyte, that is, particles of the composite active material, were obtained. The composite active material obtained is referred to as a composite active material A. The volume ratio between the positive electrode active material and the first solid electrolyte was calculated using the density of the positive electrode active material and the density of the first solid electrolyte.

### [Mixing Step]

The composite active material A, the second solid electrolyte, the CNT dispersed in a dispersion medium, and the second binder solution were mixed, with the addition of a solvent, to prepare a positive electrode slurry.

The positive electrode slurries of Examples 1 to 5 were prepared by changing the content of the CNT as the second conductive material. Table 1 shows the content of the second solid electrolyte (vol %), the content of the second conductive material (mass %), and the content of the first binder and the second binder (mass %) in the positive electrode slurries of Examples 1 to 5. The content of the second solid electrolyte shown in Table 1 is the ratio of the volume of the second solid electrolyte to the sum of the volumes of the positive electrode active material and the second solid electrolyte (100×second solid electrolyte/(positive electrode active material+second solid electrolyte)). The content of the second conductive material shown in Table 1 is the ratio of the mass of the second conductive material to the sum of the masses of the positive electrode active material and the second conductive material (100×second conductive material/(positive electrode active material+second conductive material)). The content of the first binder and the second binder shown in Table 1 is the ratio of the mass of the first binder and the second binder to the sum of the masses of the positive electrode active material and the first binder and the second binder (100×first binder and second binder/(positive electrode active material+first binder and second binder)). The same applies to Tables 2 and 3 described below.

The content of the second solid electrolyte was calculated using the density of the positive electrode active material and the density of the second solid electrolyte. The mass of the second binder was adjusted so that the sum of the mass of the first binder and the mass of the second binder would be in the ratio shown in Table 1.

TABLE 1

| | | | Content of |
|---|---|---|---|
| Positive | Content of second | Content of second | (first binder + |
| electrode | solid electrolyte | conductive material | second binder) |
| material | (vol %) | (mass %) | (mass %) |
| Example 1 | 30 | 0.005 | 0.4 |
| Example 2 | 30 | 0.01 | 0.4 |
| Example 3 | 30 | 0.02 | 0.4 |
| Example 4 | 30 | 0.04 | 0.4 |

### Comparative Examples 1 to 3

### [Positive Electrode Active Material]

As the positive electrode active material, particles of a positive electrode active material that were a plurality of core-shell composite particles (median diameter: 5 μm; density: 4.7 g/cm³) were used as in Examples 1 to 4.

### [First Solid Electrolyte]

As the first solid electrolyte, particles of LTAF were used as in Examples 1 to 4.

### [First Binder]

As the first binder, a styrene-ethylene-butylene-styrene block copolymer (N504, manufactured by Asahi Kasei Corporation) was dissolved in a dispersion medium to prepare a solution, as in Examples 1 to 4.

### [Second Binder]

As the second binder, a butadiene rubber-based binder was dissolved in a dispersion medium to prepare a solution, as in Examples 1 to 4.

### [Second Conductive Material]

As the second conductive material, the same CNT as that in Examples 1 to 4 and a vapor-grown carbon fiber (VGCF-H, manufactured by Showa Denko K.K.; average fiber diameter: 150 nm; average length: 6 μm) (hereinafter referred to as VGCF) were used.

### [Second Solid Electrolyte]

As the second solid electrolyte, LiI—LiBr—Li₂S—P₂S₅-based glass-ceramic particles (average particle diameter: 1.0 μm; density: 2.2 g/cm³) were used as in Examples 1 to 4.

### [Second Coating Step]

In Comparative Examples 1 to 3, the first conductive material was not used and accordingly the first coating step was not performed. Except for the use of the positive electrode active material instead of the base active material, the same method as that in the second coating step in Examples 1 to 4 was used to obtain particles of the positive electrode active material, at least a portion of the surface of each of which was coated with the first solid electrolyte. The coated positive electrode active material obtained is referred to as a composite active material B.

### [Mixing Step]

The composite active material B, the second solid electrolyte, the second conductive material, and the second binder solution were mixed, with the addition of a solvent, to prepare a positive electrode slurry. In Comparative Example 2, in which the CNT was used as the second conductive material, the CNT dispersed in a dispersion medium was used as the second conductive material as in the mixing step in Examples 1 to 4.

The positive electrode slurries of Comparative Examples 1 to 3 were prepared by changing the type and content of the second conductive material. Table 2 shows the content of the second solid electrolyte (vol %), the content of the second conductive material (mass %), and the content of the first binder and the second binder (mass %) in the positive electrode slurries of Comparative Examples 1 to 3.

TABLE 2

| Positive | Content of second | Second | Content of second | Content of |
|---|---|---|---|---|
| electrode | solid electrolyte | conductive | conductive | (first binder + second |
| material | (vol %) | material | material (mass %) | binder) (mass %) |
| Comparative | 30 | — | 0 | 0.4 |
| Example 1 | | | | |
| Comparative | 30 | CNT | 0.02 | 0.4 |
| Example 2 | | | | |
| Comparative | 30 | VGCF | 2.3 | 0.4 |
| Example 3 | | | | |

### Comparative Examples 4 to 7

As the composite active material, the composite active material A was used as in Examples 1 to 4.

### [Second Binder]

As the second binder, a butadiene rubber-based binder was dissolved in a dispersion medium to prepare a solution, as in Examples 1 to 4.

### [Second Conductive Material]

As the second conductive material, particles of acetylene black (Li-435, manufactured by Denka Company Limited; average particle diameter: 23 nm) (hereinafter referred to as AB) or the same VGCF as that in Comparative Example 3 were used.

### [Second Solid Electrolyte]

As the second solid electrolyte, LiI—LiBr—Li₂S—P₂S₅-based glass-ceramic particles (average particle diameter: 1.0 μm; density: 2.2 g/cm³) were used as in Examples 1 to 4.

### [Mixing Step]

The composite active material A, the second solid electrolyte, the second conductive material, and the second binder solution were mixed, with the addition of a solvent, to prepare a positive electrode slurry.

The positive electrode slurries of Comparative Examples 4 to 7 were prepared by changing the type and content of the second conductive material. Table 3 shows the content of the second solid electrolyte (vol %), the content of the second conductive material (mass %), and the content of the second binder (mass %) in the positive electrode slurries of Comparative Examples 4 to 7. The content of the second binder shown in Table 3 is the ratio of the mass of the second binder to the sum of the masses of the positive electrode active material and the second binder (100×second binder/(positive electrode active material+second binder)).

TABLE 3

| Positive | Content of | Second | Content of second | |
|---|---|---|---|---|
| electrode | second solid | conductive | conductive | Content of second |
| material | electrolyte (vol %) | material | material (mass %) | binder (mass %) |
| Comparative | 30 | AB | 0.02 | 0.4 |
| Example 4 | | | | |
| Comparative | 30 | AB | 0.1 | 0.4 |
| Example 5 | | | | |
| Comparative | 30 | VGCF | 0.02 | 0.4 |
| Example 6 | | | | |
| Comparative | 30 | VGCF | 0.1 | 0.4 |
| Example 7 | | | | |

### [Evaluation of Electronic Conductivity of Positive Electrode Active Material Layer]

The positive electrode slurries of Examples 1 to 4 and Comparative Examples 1 to 7 were each applied onto a current collector foil and dried at 100° C. to obtain a positive electrode. The positive electrode consisted of the current collector foil and a positive electrode active material layer formed on the current collector foil. The thickness of the positive electrode active material layer was adjusted in the measurement of the initial battery capacity described below so that the discharge capacity would be 2 mAh/cm².

Next, two punched positive electrodes were stacked with the positive electrode active material layers facing each other, and were roll pressed at 2 ton/cm to fabricate a positive electrode formed body. After the thickness of the positive electrode active material layer of the positive electrode formed body was measured, the positive electrode formed body was housed in an outer casing formed of a laminated sheet and compressed under 0.5 MPa. Thus, the positive electrode test pieces of Examples 1 to 4 and Comparative Examples 1 to 7.

The test pieces were each placed in a thermostatic chamber set at 25° C. Subsequently, a voltage of 0.05 V was applied between the two current collector foils of the test piece, and the current was measured after 300 seconds. The electronic conductivity of the positive electrode active material layer was calculated by the following equation (1). The results are shown in Tables 4 to 7.

$$Electronic conductivity = current / ( voltage \times thickness of positive electrode active material layer ) \qquad Equation ( 1 )$$

### [Evaluation of Initial Resistance and Resistance Change Rate]

The evaluation cells of Examples 1 to 5 and Comparative Examples 1 to 7 were fabricated by the method described below.

### (Preparation of Negative Electrode)

As the negative electrode active material, Li₄Ti₅O₁₂ particles (average particle diameter: 1.1 μm; density: 3.5 g/cm³) were used. The average diameter of the negative electrode active material was calculated by the same method as that for the positive electrode active material.

As the solid electrolyte, LiI—LiBr—Li₂S—P₂S₅-based glass-ceramic particles (average particle diameter: 1.0 μm; density: 2.2 g/cm³) were used, in the same manner as the second solid electrolyte used in the positive electrode materials of Examples 1 to 5. The average particle diameter of the solid electrolyte was calculated by the same method as that for the first solid electrolyte of Examples 1 to 4.

As the binder, a butadiene rubber-based binder was dissolved in a dispersion medium to prepare a solution, in the same manner as the second binder used in the positive electrode material of Examples 1 to 4. The content of the butadiene rubber-based binder was 5 mass % relative to the total mass of the solution.

As the conductive material, the same VGCF as that used in the second conductive material in the positive electrode materials of Comparative Examples 3, 6, and 7 was used.

The negative electrode active material, the solid electrolyte, the binder solution, and the conductive material were weighed so that the mass ratio of the negative electrode active material: the solid electrolyte: the binder solution: the conductive material would be 73.8:24.8:0.6:0.8. These were mixed with the addition of a dispersion medium to prepare a negative electrode slurry.

The negative electrode slurry was applied onto a current collector foil serving as the negative electrode current collector and dried at 100° C. to obtain a negative electrode. The negative electrode consisted of the current collector foil and a negative electrode active material layer formed on the current collector foil. The thickness of the negative electrode active material layer was adjusted so that the capacity per unit area of the negative electrode would be 1.15 times the capacity per unit area of the positive electrode.

The “capacity per unit area of the negative electrode” indicates the capacity per unit area of the negative electrode when the specific capacity of the negative electrode active material is set to 175 mAh/g. The “capacity per unit area of the positive electrode” indicates the charge capacity at the 1st cycle in the measurement of the initial battery capacity described below.

### (Preparation of Electrolyte Layer)

As the solid electrolyte, LiI—LiBr—Li₂S—P₂S₅-based glass-ceramic particles (average particle diameter: 2.5 μm; density: 2.2 g/cm³) were used. The average particle diameter of the solid electrolyte was calculated by the same method as that for the first solid electrolyte of Examples 1 to 5. The average particle diameter of the solid electrolyte used in the electrolyte layer was different from the average particle diameter of the second solid electrolyte used in the positive electrode material of the examples and the comparative examples and from the average particle diameter of the solid electrolyte used in the negative electrode of the examples and the comparative examples.

As the binder, a butadiene rubber-based binder was dissolved in a dispersion medium to prepare a solution, in the same manner as the second binder used in the positive electrode material of Examples 1 to 4. The content of the butadiene rubber-based binder was 5 mass % relative to the total mass of the solution.

The solid electrolyte and the butadiene rubber-based binder were weighed so that the mass ratio of the solid electrolyte: the butadiene rubber-based binder would be 99.6:0.4. These were mixed with the addition of a dispersion medium to prepare a solid electrolyte slurry.

### (Fabrication of Positive Electrode-Side Laminate)

The solid electrolyte slurry was applied to the surface of the positive electrode active material layer, dried at 100° C., and then roll pressed at 2 ton/cm² to obtain a positive electrode-side laminate. The positive electrode-side laminate included a positive electrode and a first electrolyte layer formed on the surface of the positive electrode.

### (Fabrication of Negative Electrode-Side Laminate)

The solid electrolyte slurry was applied to the surface of the negative electrode active material layer, dried at 100° C., and then roll pressed at 2 ton/cm to obtain a negative electrode-side laminate. The negative electrode-side laminate included a negative electrode and a second electrolyte layer formed on the surface of the negative electrode.

### (Assembly)

The positive electrode-side laminate and the negative electrode-side laminate were each subjected to a punching process. The positive electrode-side laminate, the electrolyte layer in an unpressed state (the same as the solid electrolyte layer above), and the negative electrode-side laminate were stacked in this order to obtain a stack. In the stack, the electrolyte layer in an unpressed state was interposed between the first electrolyte layer of the positive electrode-side laminate and the second electrolyte layer of the negative electrode-side laminate.

The stack was pressed at 400 MPa to obtain a power-generating element. The power-generating element included the positive electrode, the electrolyte layer formed on the positive electrode, and the negative electrode formed on the electrolyte layer. The power-generating element obtained was sealed in laminate and compressed under 0.5 MPa. Thus, a battery serving as the evaluation cell was obtained.

### (SEM-EDS Analysis on Positive Electrode Cross Section)

The evaluation cell fabricated using the positive electrode material of Example 3 was cut, and the cross section was processed using an ion milling system (ArBlade 5000, manufactured by Hitachi High-Tech Corporation). A cross section of the positive electrode active material layer was then subjected to SEM-EDS analysis and SEM analysis. The EDS detector used was Ultim Extreme, manufactured by Oxford Instruments. The accelerating voltage during the SEM-EDS analysis was 5 kV.

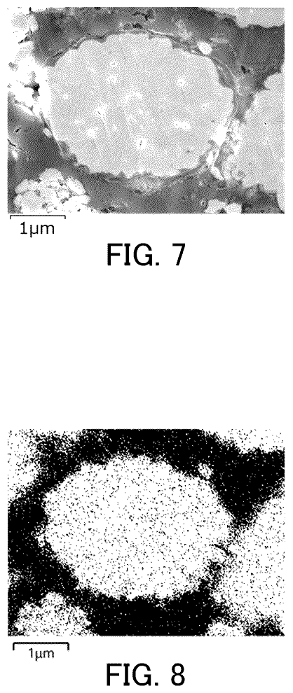

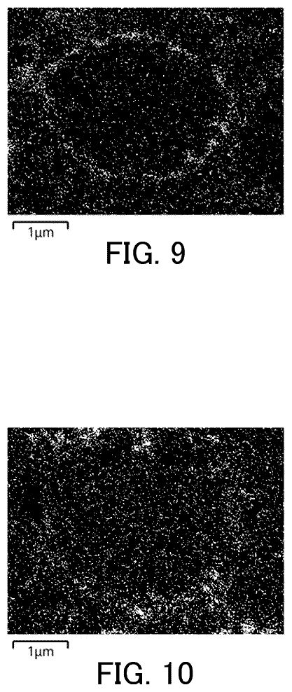

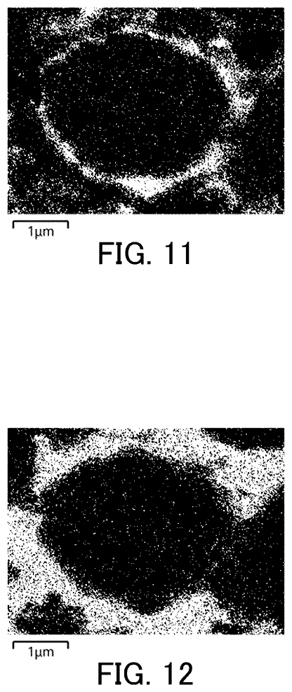

A secondary electron image and elemental mapping images obtained by EDS, both acquired at the same cross-sectional location of the positive electrode active material layer, are shown in FIGS. 7 to 12. FIG. 7 is a secondary electron image, FIG. 8 is an mapping image of the Ni component (corresponding to the positive electrode active material), FIG. 9 is an mapping image of the Nb component (corresponding to LiNbO₃), FIG. 10 is an mapping image of the C component (corresponding to the first conductive material, the second conductive material, the first binder, and the second binder), FIG. 11 is an mapping image of the F component (corresponding to the first solid electrolyte), and FIG. 12 is an mapping image of the S component (corresponding to the second solid electrolyte). In FIGS. 7 to 12, the brightly colored regions indicate the distribution of the respective components.

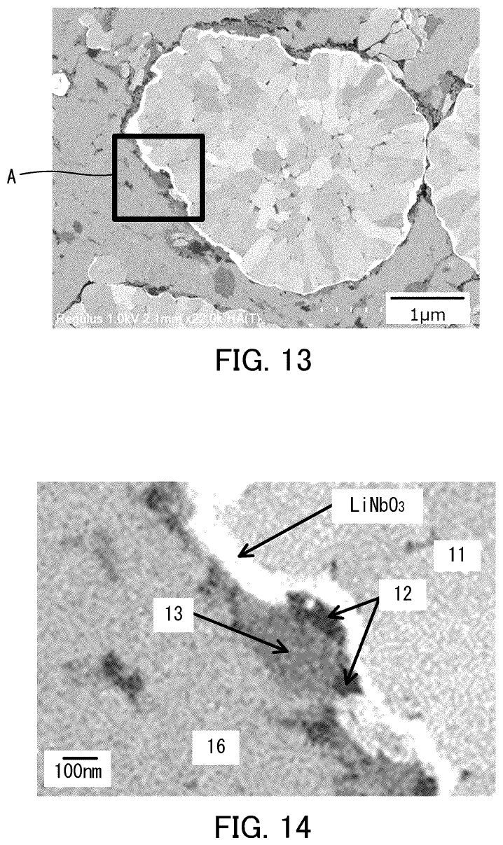

FIG. 13 is a cross-sectional backscattered electron image of the positive electrode active material layer captured at an accelerating voltage of 1 kV, and FIG. 14 is an enlarged view of a region A in FIG. 13. The structure of the positive electrode material shown in FIG. 14 was identified based on the results of the elemental mapping and the color tones appearing in the backscattered electron image shown in FIGS. 7 to 12.

From FIGS. 7 to 12, it was found that, on the surface of the particle of the positive electrode active material having a core formed of Li(Ni,Co,Al)O₂ and a shell formed of LiNbO₃, the first conductive material and the first solid electrolyte were distributed. From FIG. 13, it was confirmed that the second solid electrolyte was present between particles of the positive electrode active material.

As shown in FIGS. 13 and 14, the first conductive material 12 was preferentially disposed inside the recesses on the surface of the positive electrode active material 11. Outside the recesses, there was a region where the first conductive material 12 was not disposed. In the region of the surface of the positive electrode active material 11, where the first conductive material 12 was not disposed, the first solid electrolyte 13 was disposed. The CNT used as the second conductive material 15 has a small fiber diameter and was added in a small amount, and accordingly, its distribution could not be confirmed in FIGS. 13 and 14.

### (Measurement of Initial Resistance)

First, the evaluation cell was placed in a thermostatic chamber set at 25° C. Subsequently, the operation of charging the evaluation cell and then discharging the evaluation cell (hereinafter also referred to as a “charge and discharge cycle”) was performed twice.

The charge of the evaluation cell was performed as follows: the evaluation cell was charged at a constant current of ⅓C rate until the voltage of the evaluation cell reached 2.7 V, followed by charging at a constant voltage until the charging current reached an equivalent of 0.01C, at which point charging was terminated. The charging rate was calculated from the designed capacity of the evaluation cell (capacity per unit area of the positive electrode: 2 mAh/cm²).

The discharge of the evaluation cell was performed as follows: the evaluation cell was discharged at a constant current of ⅓C rate until the voltage of the evaluation cell reached 1.5 V, followed by discharging at a constant voltage until the discharging current reached an equivalent of 0.01C, at which point discharging was terminated.

Next, the evaluation cell was charged at a constant current of ⅓ rate until the voltage of the evaluation cell reached 2.2 V, followed by charging at a constant voltage until the charging current reached an equivalent of 0.01C, at which point charging was terminated. The evaluation cell was left standing for 1 minute, and then discharged at a current of 24C rate for 10 seconds. The value obtained by dividing the voltage drop of the evaluation cell, from immediately before the start of the discharge to 0.1 seconds after the start of the discharge, by the current value was defined as the initial resistance R₁. The results are shown in Tables 4 to 7.

Subsequently, the evaluation cell was discharged at a constant current of ⅓C rate until the voltage of the evaluation cell reached 1.5 V, followed by discharging at a constant voltage until the discharging current reached an equivalent of 0.01C, at which point discharging was terminated.

(Measurement of Resistance after Cycle Test)

The evaluation cell was placed in a thermostatic chamber set at 60° C. and subjected to a cycle test. In the cycle test, the charge and discharge cycle was repeated 150 times.

The charge of the evaluation cell was performed as follows: the evaluation cell was charged at a constant current of 5C rate until the voltage of the evaluation cell reached 2.7 V, followed by charging at a constant voltage until the charging current reached an equivalent of ⅓C, at which point charging was terminated.

The discharge of the evaluation cell was performed as follows: the evaluation cell was discharged at a constant current of 1C rate until the voltage of the evaluation cell reached 1.8 V.

Next, the evaluation cell was placed in a thermostatic chamber set at 25° C., and charged at a constant current of ⅓C rate until the voltage of the evaluation cell reached 2.2 V, followed by charging at a constant voltage until the charging current reached an equivalent of 0.01C, at which point charging was terminated. The evaluation cell was left standing for 1 minute, and then discharged at a current of 24C for 10 seconds. The value obtained by dividing the voltage drop of the evaluation cell, from immediately before the start of the discharge to 0.1 seconds after the start of the discharge, by the current value was defined as the resistance R₂ after the cycle test. The value obtained by dividing the resistance R₂ after the cycle test by the initial resistance R₁ (R₂/R₁) is shown in Tables 4 to 7.

The content of the second conductive material shown in Tables 4 to 7 is the ratio of the mass of the second conductive material to the sum of the masses of the positive electrode active material and the second conductive material (100×second conductive material/(positive electrode active material+second conductive material)).

TABLE 4

| | Composite active | | | | | | |
|---|---|---|---|---|---|---|---|
| | material | | | Content of | | | |
| | Coating | Coating | | second | | Initial | |
| Positive | with first | with first | Second | conductive | Electronic | resistance | |
| electrode | conductive | solid | conductive | material | conductivity | R₁ | |
| material | material | electrolyte | material | (mass %) | (mS/cm) | (Ω · cm²) | R₂/R₁ |
| Example 1 | Present | Present | CNT | 0.005 | 0.03 | 9.3 | 1.03 |
| Example 2 | Present | Present | CNT | 0.01 | 0.05 | 8.7 | 1.09 |
| Comparative | Absent | Present | — | 0 | 0.04 | 10.5 | 1.31 |
| Example 1 | | | | | | | |
| Comparative | Present | Present | AB | 0.02 | 0.03 | 10.0 | 1.05 |
| Example 4 | | | | | | | |
| Comparative | Present | Present | AB | 0.1 | 0.03 | 12.1 | 1.08 |
| Example 5 | | | | | | | |
| Comparative | Present | Present | VGCF | 0.02 | 0.03 | 11.0 | 1.01 |
| Example 6 | | | | | | | |
| Comparative | Present | Present | VGCF | 0.1 | 0.02 | 10.9 | 1.05 |
| Example 7 | | | | | | | |

The electronic conductivity of the positive electrode active material layers of Examples 1 and 2 was comparable to the electronic conductivity of the positive electrode active material layers of Comparative Examples 1 and 4 to 7. However, the initial resistance R₁ of the evaluation cells of Comparative Examples 1 and 4 to 7 was higher than the initial resistance R₁ of the evaluation cells of Examples 1 and 2, and was 9.5 Ω·cm² or more. It is presumed that the higher initial resistance R₁ of the evaluation cell of Comparative Examples 1 than the initial resistance R₁ of the evaluation cells of Examples 1 and 2 resulted from the fact that the positive electrode material of Comparative Example 1 did not include the second conductive material, consequently failing to ensure uniformity of the electrochemical reactions in the positive electrode active material layer. It is presumed that the higher initial resistance R₁ of the evaluation cells of Comparative Examples 4 to 7 than the initial resistance R₁ of the evaluation cells of Examples 1 and 2 resulted from either the fact that the second conductive material included in the positive electrode materials of Comparative Examples 4 to 7 was not a fibrous carbon material, or the fact that the average diameter or average fiber diameter of the second conductive material of Comparative Examples 4 to 7 was large and its content was high: either of which caused the second conductive material to narrow the ionic conduction paths within the positive electrode active material layer, consequently failing to ensure uniformity of the electrochemical reactions.

TABLE 5

| | Composite active | | | | | | |
|---|---|---|---|---|---|---|---|
| | material | | | Content of | | | |
| | Coating | Coating | | second | | Initial | |
| Positive | with first | with first | Second | conductive | Electronic | resistance | |
| electrode | conductive | solid | conductive | material | conductivity | R₁ | |
| material | material | electrolyte | material | (mass %) | (mS/cm) | (Ω · cm²) | R₂/R₁ |
| Example 3 | Present | Present | CNT | 0.02 | 12 | 6.1 | 1.41 |
| Comparative | Absent | Present | CNT | 0.02 | 7 | 6.9 | 1.49 |
| Example 2 | | | | | | | |

The content of the second conductive material in the positive electrode material of Example 3 was equal to the content of the second conductive material in the positive electrode material of Comparative Example 2. However, the electronic conductivity of the positive electrode active material layer of Comparative Example 2 was lower than the electronic conductivity of the positive electrode active material layer of Example 3. This is presumed to result from the fact that the positive electrode material of Comparative Example 2 did not include the first conductive material, consequently failing to ensure uniformity of the electrochemical reactions in the positive electrode active material layer. Furthermore, the initial resistance R₁ and R₂/R₁ of the evaluation cell of Comparative Example 2 were respectively higher than the initial resistance R₁ and R₂/R₁ of the evaluation cell of Example 3. This is presumed to result from the fact that the positive electrode material of Comparative Example 2 did not include the first conductive material, failing to form an electronic conduction path via the first conductive material and consequently failing to ensure uniformity of the electrochemical reactions throughout the positive electrode active material layer.

TABLE 6

| | Composite active | | | | | | |
|---|---|---|---|---|---|---|---|
| | material | | | Content of | | | |
| | Coating | Coating | | second | | Initial | |
| Positive | with first | with first | Second | conductive | Electronic | resistance | |
| electrode | conductive | solid | conductive | material | conductivity | R₁ | |
| material | material | electrolyte | material | (mass %) | (mS/cm) | (Ω · cm²) | R₂/R₁ |
| Example 3 | Present | Present | CNT | 0.02 | 12 | 6.1 | 1.41 |
| Comparative | Absent | Present | VGCF | 2.3 | 10 | 6.4 | 1.44 |
| Example 3 | | | | | | | |

In the positive electrode material of Comparative Example 3, as in the positive electrode material of Comparative Example 2, the first conductive material was not included in the coating material coating the positive electrode active material. As can be seen from the comparison between the electronic conductivity of the positive electrode active material layer of Example 3 and the electronic conductivity of the positive electrode active material layer of Comparative Example 3, when the first conductive material was not included in the coating material coating the positive electrode active material, the addition of 2.3 mass % of a vapor-grown carbon fiber as the second conductive material enabled an increase in the electronic conductivity of the positive electrode active material layer to a level close to that of Example 3. However, the initial resistance R₁ and R₂/R₁ of the evaluation cell of Comparative Example 3 were respectively higher than the initial resistance R₁ and R₂/R₁ of the evaluation cell of Example 3. This is presumed to result from the fact that the excessively high content of the second conductive material in the positive electrode material caused the second conductive material to narrow the ionic conduction paths within the positive electrode active material layer, consequently failing to ensure uniformity of the electrochemical reactions.

TABLE 7

| | Composite active | | | | | | |
|---|---|---|---|---|---|---|---|
| | material | | | Content of | | | |
| | Coating | Coating | | second | | Initial | |
| Positive | with first | with first | Second | conductive | Electronic | resistance | |
| electrode | conductive | solid | conductive | material | conductivity | R₁ | |
| material | material | electrolyte | material | (mass %) | (mS/cm) | (Ω · cm²) | R₂/R₁ |
| Example 1 | Present | Present | CNT | 0.005 | 0.03 | 9.3 | 1.03 |
| Example 2 | Present | Present | CNT | 0.01 | 0.05 | 8.7 | 1.09 |
| Example 3 | Present | Present | CNT | 0.02 | 12 | 6.1 | 1.41 |
| Example 4 | Present | Present | CNT | 0.04 | 18 | 6.6 | 1.62 |

The positive electrode materials of Examples 1 to 4 differed from each other in the content of the second conductive material. As shown in Table 7, in the evaluation cells of Examples 1 to 4, the initial resistance R₁ was reduced, and also the increase in the resistance upon repeated charging and discharging was suppressed. Furthermore, as can be seen from the comparison of the electronic conductivity of the positive electrode active material layers of Examples 1 to 4, in the evaluation cells of Examples 1 to 3, in which the content of the second conductive material was 0.005% or more and 0.02% or less, R₂/R₁ was 1.5 or less, which indicated that the increase in the resistance upon repeated charging and discharging was further suppressed. This is presumed to result from the fact that the content of the fibrous carbon material in the positive electrode active material layer was not excessively high not only made the second solid electrolyte less likely to decompose during charging of the evaluation cell, but also suppressed the narrowing of the ionic conduction paths within the positive electrode active material layer.

As described above, according to the present disclosure, it is possible to provide a positive electrode material that can reduce the initial resistance of the battery and can also suppress an increase in the resistance of the battery upon repeated charging and discharging.

### INDUSTRIAL APPLICABILITY

The positive electrode material of the present disclosure is used, for example, in batteries (e.g., all-solid-state lithium-ion secondary batteries).

What is claimed is:

1. A positive electrode material comprising:
a positive electrode active material;
a coating material comprising a first conductive material and a first solid electrolyte, the coating material coating at least a portion of a surface of the positive electrode active material;
a second conductive material that is a fibrous carbon material; and
a second solid electrolyte, wherein
the first solid electrolyte comprises Li, Ti, M, and F,
the M is at least one selected from the group consisting of Ca, Mg, Al, Y, and Zr, and
the second conductive material has an average fiber diameter of 0.4 nm or more and 50 nm or less.

2. The positive electrode material according to claim 1, wherein
the first conductive material coats at least a portion of the surface of the positive electrode active material, and
the first solid electrolyte coats at least a portion of a surface of a base active material, the base active material comprising the first conductive material and the positive electrode active material.

3. The positive electrode material according to claim 1, wherein
the second conductive material and the second solid electrolyte are positioned between particles of a composite active material, the composite active material comprising the positive electrode active material and the coating material.

4. The positive electrode material according to claim 1, wherein
the M comprises Al.

5. The positive electrode material according to claim 1, wherein
a ratio of a mass of the second conductive material to a sum of a mass of the positive electrode active material and the mass of the second conductive material is 0.005% or more and 0.02% or less.

6. The positive electrode material according to claim 1, wherein
the second solid electrolyte comprises a sulfide solid electrolyte.

7. The positive electrode material according to claim 1, wherein
the first conductive material is a particulate material.

8. The positive electrode material according to claim 7, wherein
the first conductive material has a median diameter of 100 nm or less.

9. The positive electrode material according to claim 1, wherein
the positive electrode active material is in a form of a particle having a plurality of recesses on a surface thereof, and
the first conductive material is disposed in the plurality of recesses.

10. A positive electrode comprising:
a positive electrode current collector; and
a positive electrode active material layer supported on the positive electrode current collector, wherein
the positive electrode active material layer comprises the positive electrode material according to claim 1.

11. A battery comprising:
the positive electrode according to claim 10; and
a negative electrode.

12. The battery according to claim 11, further comprising an electrolyte layer positioned between the positive electrode and the negative electrode.
